(19) United States
(12) Patent Application Publication
(10) Pub. No.: US 2010/0010940 A1
(43) Pub. Date: Jan. 14, 2010

(54) Method for probabilistic information fusion to filter multi-lingual, semi-structured and multimedia Electronic Content

(76) Inventors: Konstantinos Spyropoulos, Vrilissia Attikis (GR); Georgios Paliouras, Egaleo Attikis (GR); Konstantinos Chandrinos, Lambrini Attikis (GR); Evangelos Karkaletsis, Halandri Attikis (GR); Ioannis Androutsopoulos, Voula Attikis (GR)

Correspondence Address: Bruce L. Adams;Adams & Wilks, 17 Battery Place, Suite 1231, New York, NY, 10014, US

(21) Appl. No.: 11/919,563

(22) PCT Filed: Apr. 28, 2006
(86) PCT No.: PCT/GR2006/000021

§ 371 Date: Oct. 30, 2007

(30) Foreign Application Priority Data
May 4, 2005 (GR) 20050100216

(51) Int. Cl. G06F 15/18

(52) U.S. Cl. 706/12; 706/52; 706/54

(57) ABSTRACT

The invention belongs to the field of information system technology and more specifically in the area of electronic content management. The invention concerns method producing filtering systems of electronic documents that contain text in different languages, e.g. English, French, etc., as well as multimedia elements, e.g. digital images and/or digital video and/or digital excerpts of audio/speech. These documents can be semi-structured, i.e., they can exhibit structural features that are not to be found in non-digital documents, e.g. hyperlinks, or not.

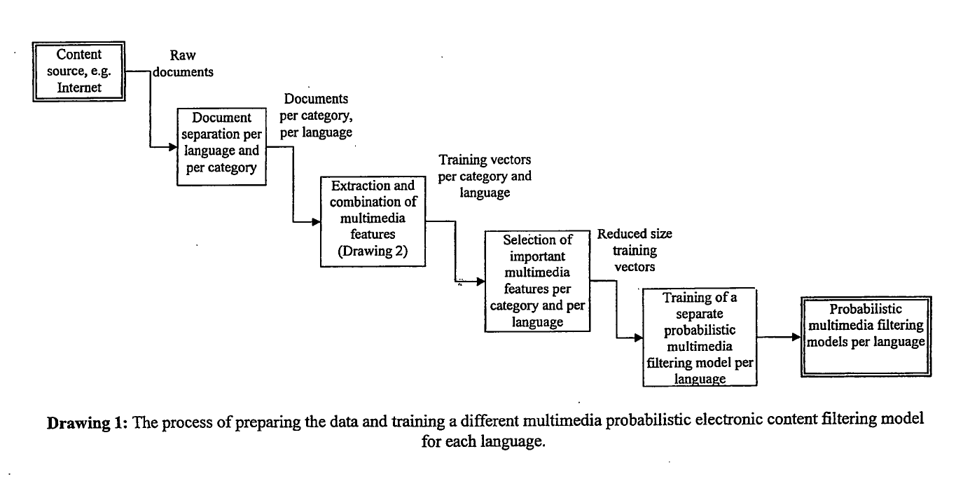

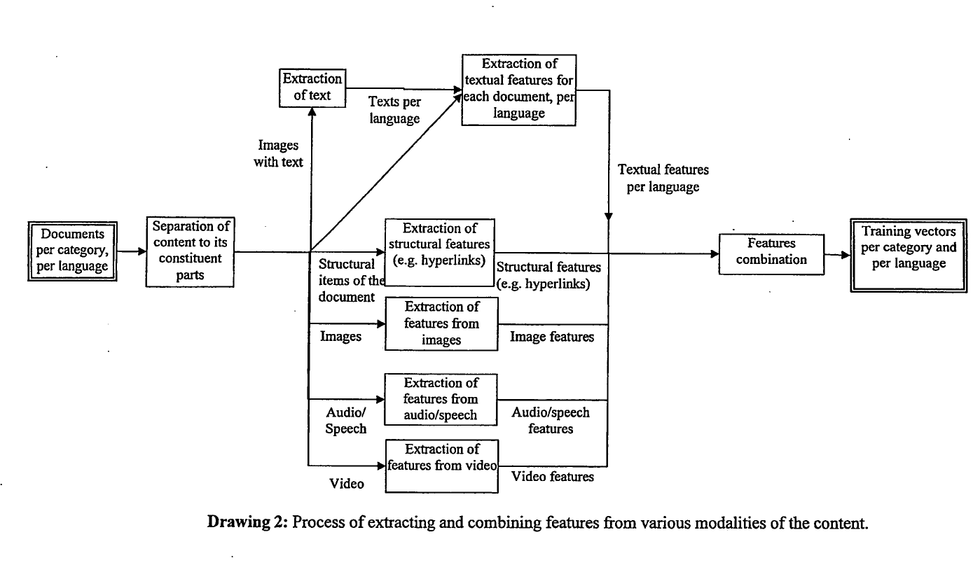

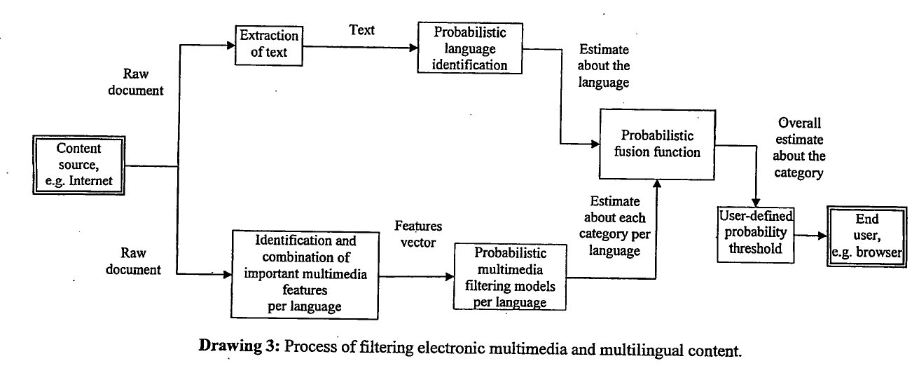

The method can be applied in the same way and provides the same results either to the filtering of electronic content in the Internet (World Wide Web, electronic mail, etc.) or in organizational computer networks (e.g. intranets), as well as in any other network that allows the transfer of multimedia and/or multilingual electronic content.

It is applicable to a wide range of companies, industries and handicrafts, that use either Internet-based services or an internal computer network, but also covers the needs of individual users, who make use of Internet-based services.

The invention belongs to the field of information system technology and more specifically in the area of electronic content management. The invention concerns the filtering of electronic documents that contain text in different languages, e.g. English, French, etc., as well as multimedia elements, e.g. digital images or/and digital video or/and digital excerpts of audio/speech. Furthermore, these documents can be semi-structured, i.e., they can exhibit structural features that are not to be found in non-digital documents, e.g. hyperlinks, or not.

The rapid development of the Internet and its penetration in our everyday life, combined with the development of third-generation (3G) telecommunications, has contributed significantly to the development of the knowledge society and the electronic business. However, it has also led to a number of problems, such as the information overload for its users, the distribution of illegal and harmful content, the feeling of insecurity when accessing Web sites of organizations and companies, the undesirable distribution of bulk advertising material, the facilitation of the manipulation of underage, the overloading of the network infrastructure and the loss of time due to the unintended loading of undesirable material by the user.

These problems have led a large proportion of our society, including many organizations and companies, to be skeptical about the adoption of full electronic communication and the wealth of possibilities provided by the technology. Therefore, the development of products and technology that improve the management of knowledge and the communication of information over the Internet is particularly important for the wider adoption of the Internet, leading among other things to improved management of personal and working time, as well as safer upbringing of underage.

The semantic variety of the content on the Internet does not allow its full and unambiguous semantic characterization, which would provide the ideal solution to the problems of knowledge management, making it possible for the user to determine the kind of content that he does not wish to receive. In this direction of the semantic characterization, the World Wide Web Consortium has proposed a specific representation for metadata, named Platform for Internet Content Selection (PICS), which has made it technically possible to add attributes in the form of metadata to HTML pages. This addition can be realised manually either by the authors of the sites or by other competent intermediaries, in order to semantically characterize Internet's content. Popular Web browsers have been extended so as to support the handling of PICS metadata, in order to provide the users with personalized content management. Soon it became apparent that the manual characterisation of the Internet according to PICS was an inadequate solution to the problem, especially due to the requirement for cooperation of the content producers. The authors of Web pages, containing illegal and harmful content are not motivated for such cooperation. Furthermore, whenever manual characterisation has been performed, it is practically impossible to enforce the accuracy and standardization of the metadata.

For this reason, manual content characterization has been proved up to this day inadequate method and has not helped the user to control the content he desires not to receive. As a result, filtering technology has been developed, which characterizes electronic content automatically, without relying on the existence or/and correctness of metadata.

Similar problems occur outside the realm of the Internet, in organizational computer networks (e.g. intranets), where it is essential to filter the content that is being distributed inside the organization for various reasons, e.g. forwarding electronic mail to the appropriate department or employee, avoiding malicious or accidental leakage of sensitive information, etc. Similar to the Internet, the characterization of the content by its author in organizational computer networks has been proved difficult and inaccurate, regarding the desired result and the accurate of the statement.

Electronic content filtering technology was developed primarily, attempting to solve the above-mentioned problems, through the automatic characterisation of content, according to a pre-defined set of categories, which can be further characterized by the user as desirable and undesirable content categories. A typical example of filtering on the Internet is the categorisation of Web pages as “pornographic” and “non-pornographic”. The demand for a definite decision on the right category for each document is the main characteristic as well as the main difficulty of filtering systems, contrary to the majority of knowledge management systems. Knowledge management systems usually focus on the discovery of the content that is conceptually related to existing content, based on some metric of semantic proximity.

One of the main problems of existing content filtering methods, is that in the process of making a clear and definite decision, some documents that belong in a category are missed (errors of this type are called under-detection or underblocking), while some documents that do not belong in a category are incorrectly assigned to it (errors of this type are called over-detection or overblocking).

Some of the existing approaches in the area of electronic content filtering, especially on the Internet, are based on the use of intermediate proxy servers, which control the address (URI) of the incoming content. If this address exists in a pre-defined catalogue of characterized addresses (e.g. pornographic Web pages) the content is considered to belong to this category, and the user is able to deny its receipt. Such a method was described in patent number U.S. Pat. No. 6,233,618 B1. However, the main problem that this method faces was the creation and updating of the catalogues for the categories of interest. Insufficient updating of the catalogues has led to the problem of under-detection (underblocking) mentioned above, which rendered this solution inadequate for the majority of content filtering problems.

Simultaneously, an alternative approach is proposed in patent number U.S. Pat. No. 5,996,011, where the corresponding software has been extended to allow the further categorisation of content according to key-words or key-phrases identified in the text. This approach is also problematic, primarily due to the problem of over-blocking (which is the opposite problem from the one faced by catalogue-based methods) due to the ignorance of the semantic context, within which key-words or key-phrases appear. For instance, a system filtering pornographic content that uses key-words may categorise as pornographic Web pages that concern body hygiene, the prevention of sexual abuse and rape, etc. and thus, the user will unknowingly miss potentially desirable and useful information (overblocking problem).

More recent approaches to the problem were based on the use of machine learning methods (e.g. neural networks) for the identification of the characteristic features of content belonging in a category. An important advantage of these approaches was their ability to automatically assign contribution weights to the characteristic features that they identify. This fact has facilitated the use of many features and the identification of fine separating lines between categories, through complex content categorization functions. Such a method is reported in patent number U.S. Pat. No. 6,266,664. The method described there uses neural networks for the categorization of Internet content, based on the features of its textual content. The method concerns only the textual content, which should also be written in the particular language that was used in the training of the neural network. As a result, if the text is written in a different language, the trained filtering system cannot be applied. Furthermore, the method cannot make use of information that is found in multimedia content, as well as in the structure of the document (e.g. the hyperlinks of a Web page), so the information of the multimedia content or of the hyperlinks is not tested, leading to imperfect filtering results. Electronic documents usually contain multimedia, semi-structured content and multilingual, and consequently, for a filtering method to be effective, must be able to filter content with those characteristics. The behavior of a method without this ability, such as this of patent number U.S. Pat. No. 6,266,664, on real data, is problematic and prone to under-detection, e.g. in the case of content that does not contain large pieces of text.

A partial solution to this problem, in particular the use of semi-structured multimedia, but not multilingual, content, is reported in the method of patent application number CA 2,323,883/US 2002/0059221 A1, which in part aims to filter semi-structured multimedia content, but has the disadvantage of not using machine learning. More specifically, regarding the text in the document, this method uses manually-defined keywords, similarly to the method of the patent number U.S. Pat. No. 5,996,011 that was mentioned above, and suffers from the same disadvantages. Regarding the multimedia content in the document, the method examines specific characteristics of digital images, speech and video. These characteristics are manually pre-defined, thus leading to under-detection. Regarding the use of the structure of the document in order to arrive at a final decision, the method simply adds together different characteristics of the documents that are hyper-linked, without using a common estimation model taking into account the participation of each modality (i.e., text, image, sound, etc.). The combination of the estimations that arise from the different modalities is achieved through a weighted average, where the weights are determined by the user. This is equivalent to the manual construction of filtering rules, a cumbersome process, especially when the rules need to be adapted to new kinds of documents. In other words, the limited type of analysis of content in different modalities and the limited combination of the arising estimations, leads to an inadequate solution of the problem, causing primarily problems of over-detection, for instance when key-words are misinterpreted. Furthermore, the particular method does not address the multilinguality of electronic documents and it is therefore not applicable to multilingual documents.

Another partial solution to the problem, in particular the use only of multilingual, but not multimedia and semi-structured content, is reported in the methods presented in patents number U.S. Pat. No. 6,542,888 and U.S. Pat. No. 6,411,924. In addition to the fact that these methods also cannot handle multimedia content, they are also based on a pre-defined category model for each language, using key-words predefined for each language and therefore equally suffer from the problem of over-detection. In other words, this approach is equivalent to the manual construction of filtering rules, with the above-mentioned problems.

Hence, the current state of the art does not provide an adequate method to manage simultaneously and in a unified manner, text written in different languages (multilingual content), the structure of a document and the multimedia elements that may be contained in the same electronic document, a combination which is very common, as for instance in Web pages that contain text, digital images, digital video or digital audio extracts, also.

In conclusion, the disadvantages of the above-mentioned state-of-the-art methods, show that the accurate assignment of a document in a category is not possible through the independent categorization of different parts of the document, expressed using different modalities, and the simplistic combination of the resulting estimates, which is the approach adopted by the current methods until today. The accurate assignment of a document in a category can only be achieved through the fusion of information in a unified multilingual and multimedia probabilistic decision model. For this reason, a filtering system, e.g. of pornographic Web pages, that decides separately for each modality, i.e. seperately for the text, the digital images, etc., cannot avoid the over-detection when processing multimedia documents concerning sexual hygiene or education, which are likely to contain images of naked people but in a non-pornographic context. This is the case, for instance, in medical Web pages, explaining how to prevent unwanted pregnancy or sexually transmitted diseases. The above presented methods will process separately each part of these multimedia documents and may well decide that one or more parts of them are pornographic, e.g. a video that shows the correct use of condoms, which is not the case.

The present method is the first one that combines, in the same probabilistic model, estimates of categorization models handling different languages and different modalities for the characteristics of multimedia and semi-structured documents, adapted to the category in question, thus examining the entire content and resulting in a more accurate decision about the category in which the total content finally belongs.

The innovative step of this present method is that, for the first time ever, it combines methods for the extraction of features from multimedia and structural data (text, structural aspects, e.g. hyperlinks, digital images, digital sound/speech and digital video), with methods of automatic selection of important filtering features. The selection of features is based on their statistical properties, measured on real example documents by machine learning methods that construct probabilistic filtering models. The selected features participate in the filtering models according to their automatically calculated degree of relatedness to each category. Based on the filtering models a final decision can be made, using probabilistic information fusion methods as well as methods for the automatic identification of the language of the text.

More specifically, the present method adheres to the following processing steps for each language handled by the system: (a) automatic extraction of characteristic features from all the modalities and the structure of the documents, (b) automatic selection of the most important features for the purposes of filtering, (c) creation of a multimedia filtering model that combines the multimedia and structural features of the document, extracted and selected in the previous steps, using a machine learning method on example documents, and (d) use of the filtering model in order to estimate the probability of new documents, beyond the example ones, to belong to the specific category. Instead of examining the features of each modality separately and arriving at independent estimates per modality, the present method creates a unified representation of the document (e.g. a vector of features from all modalities, text, still and moving images, sound, etc.) and then uses the trained filtering model in order to estimate the degree of relatedness of the features in the document to each category, for their contribution to the decision about the document. Immediately afterwards, the estimations of the different language models for a particular document, are combined with probabilistic estimates about the language or languages in which the text of the document is written. This combination is based on a probabilistic fusion function. The inventive step is on the unified representation of all the characteristic features of the multimedia and/or multilingual document, regardless the modality or “feature” they originate, as well as on the combination of the various methods and steps, in order to provide a more complete confrontment of the problem of filtering electronic content, compared to that provided by the state-of-the-art methods.

Thereby, the present invention differs from the methods that are based on manual construction of catalogues of electronic addresses or rules based on key-words and predefined features, such as those described in patents number U.S. Pat. No. 6,233,618, U.S. Pat. No. 5,996,011, CA 2,323,883, U.S. Pat. No. 6,542,888 and U.S. Pat. No. 6,411,924. The main advantage of the present invention compared to these methods, is that it applies probabilistic fusion of estimates of various characteristic features extracted from various modalities as well as the structure of an electronic document, for each language. These estimates in turn, are based on machine learning methods, thus avoiding all the disadvantages of the state-of-the-art methods, such as the selection of addresses to be included in a catalogue, the updating of the catalogue, the use of key-words and the construction of filtering rules. It is, therefore, an important advantage of the method, its independence from address catalogues, key-words, and manually constructed filtering rules, which are used by most of the state-of-the-art methods. In this manner, the present method achieves the broadest possible coverage of electronic content and its most accurate filtering, minimizing simultaneously both, over-detection and under-detection, as it makes an overall conclusion about the content and does not rely on conclusions concerning specific parts of the content, neither adds results of decisions for each part. Moreover, the method differs from the method presented in the pattern number U.S. Pat. No. 6,266,664, which has the disadvantage of not being applicable to the filtering of multilingual and multimedia content.

The method leads to the construction of filtering systems (filters) that estimate the probability that an unknown document belongs to the examined category, an advantage which allows the developer of the filter or even the final user the ability to calibrate the filtering process on the basis of whether the calculated probability exceeds a certain possibility/threshold value of the document, in order to be assigned to the category. Such a probability/threshold is provided by the person who produces the filter, using the present method, but is not necessarily binding for the final users, who may be given by the developer the selection to adapt the threshold according to their judgment and their preferences.

Another advantage of the present invention is the participation of the language identification to the categorization of the documents, which allows the system to filter documents that not only contain text in one of the chosen languages, but also mixed, i.e. texts containing passages written in different languages.

A further advantage of the method is the fact that every feature of every modality contributes to a different degree to the probabilistic model that is constructed, depending on the category that gets modeled. For instance, the existence of faces in images that exist on Web pages will have a different degree of contribution to the construction of the model if the target is the filtering of pornographic pages, than if the target is the filtering of racist material. This property of the method increases the precision of the filtering model and as a result the precision of filtering the multimedia and multilingual documents.

Yet another advantage of the method is the development of a multimedia model for each language and the use of this model on the basis of the probability that the examined multimedia content contains text in a particular language. This property provides an important advantage to the method in the processing of multilingual documents in the most flexible and precise manner.

Finally, another advantage of the present invention is that it can be applied in the same way and provides the same results either to the filtering of electronic content on the Internet (World Wide Web, electronic mail, etc.) or in organizational computer networks (e.g. intranets), as well as in any other network that allows the transfer of multimedia and/or multilingual electronic content, such as, e.g. the third and following generation mobile telecommunication networks.

The application of the present method for the filtering of electronic content is separated into two distinct stages:

(a) training of a probabilistic multimedia filtering model for each language supported by the system, by the developer of the filters, who in some cases can be also the final user, with the use of machine learning methods, and

(b) filtering of multimedia and multilingual electronic documents with the use of the trained models, fusing their results, in order to arrive at an overall conclusion about the document.

An embodiment of the present invention, with reference to non-limiting examples and the drawings, is presented below:

Drawings 1 to 3 present schematically these two stages and will be used in the detailed description of the method that follows.

Drawing 1 presents the process of preparing the data and the training of the filtering models.

Drawing 2 presents the subprocess of extracting and combining characteristic features from various modalities of the content, a subprocess that is being used in the training process described in drawing 1.

Drawing 3 presents the process of filtering multimedia and multilingual content, through the fusion of the results of the trained models.

For the training of the probabilistic filtering models, machine learning methods are used, which presuppose the pre-construction of a set of training data, based on pre-categorised documents, e.g. a user can determine which Web pages or which electronic mail messages are undesirable, thus providing training examples.

Drawing 1 presents the preparation process of those training data.

First, the developer of the filters, who in some cases can be the user itself, collects training documents. A subset of the framing documents belongs to the categories of interest, e.g. undesirable electronic mail messages. These documents are separated in the categories that they belong to, by the filter trainer/developer who is considered to be an expert in the categorization of such documents. In some cases, this categorization may not be necessary, e.g. undesirable electronic mail messages can be selected from collections of such documents that are publicly available on the Web (spam collections).

Then, the documents are separated according to the language of the text that they contain. In the training phase it is preferable to use documents that contain text fully or mostly written in a single language. The identification of the language for each document is either done by a human or with the assistance of a system that performs automatic language identification, such as the system [symbol] Qué? from Alis Technologies.

When this second separation of the documents, according to the language, is completed, each document is subdivided into constituent parts that may contain text, structural components (e.g. hyperlinks), digital images, digital sound/speech and digital video. In the case where some of the images contain text, the text is extracted using a common optical character recognition algorithm and it is added to the rest of the text.

Then, characteristic features are extracted from each modality of the document, with the assistance of appropriate processing algorithms and the extracted features are combined into a unified representation of the document (subprocess of drawing 1 that is analysed in drawing 2). Regarding the text, a non-limiting embodiment of the method uses an algorithm to extract words and small phrases, e.g. up to 3 words, from the text, ignoring frequent words of each language. A non-limiting embodiment of the method, uses also a second algorithm to record the linking between documents of the same category (if for example the documents are Web pages), a third algorithm that recognizes faces or face features in digital images and/or other algorithms for the recognition of human speech in audio and video extracts.

The features extracted from each document are combined in a unifying feature vector, regardless of the “constituent part” of the document that they come from, in order to generate a training example for the filtering model. Thus, the feature vector contains information from all parts of the document, together with information about the category of the example document, e.g. pornographic Web page. All example documents generated in this manner and containing text of the same language are the training data for the filtering model of that language.

Having constructed all the training data per language, coming from their preparing process presented in drawing 1 and with the use of the subprocess presented in drawing 2, the next stage for the application of the method is the training of the model for each language, which is also presented in drawing 1.

The training process for each filtering model comprises two main stages: (a) the automatic selection of a subset of features, the statistical properties of which show that they are important for the categorization of the documents in the categories of interest, e.g. phrases that invite the user to buy products, common in many undesirable electronic mail messages (spam), and (b) the construction of a model which calculates the relatedness of the selected features to the categories, maximizing the ability of categorizing the example documents, to the categories of interest, as these are defined by the developer of the system.

In a non-limiting embodiment of the method, if for instance the goal of filtering is to identify Web pages containing pornographic content, during the preparation of the training data by the developer, who in this case is usually the company providing the filter, various features will be extracted from the “content” of the document, according to the above-described process and drawing 2. Some of these features will be selected as the most important ones according to their contribution in separating Web pages into pornographic and non-pornographic. This feature selection process is based on the statistical properties of the features (e.g. the frequency of appearance of words and phrases in pornographic and non-pornographic documents, the frequency and topology of appearance of naked flesh in pornographic and non-pornographic documents, etc.) and is performed automatically according to known methods for feature selection that are described in the machine learning literature (e.g. T. Mitchell, “Machine Learning”, McGraw Hill, 1997). These statistical properties are measured in the example documents of the training dataset. Then, a machine learning algorithm weighs and combines these selected features in a probabilistic model, of the category “pornographic Web pages” for each language. The exact choice of machine learning algorithm is not important for the present method, as long as the model that is learned can be used for the probabilistic estimation of the category of the document.

In another non-limiting embodiment of the method described in drawing 1, where the goal is for instance to train a filtering system for non invited or/and undesirable electronic mail messages (spam), the system is trained by the final user, using examples of acceptable messages from the user's personal mailbox, in contrast to spam messages that either the user has received or are provided by the developers of the filtering system or come from an other source. During the training process, the system extracts characteristic features from each message, as explained above (drawing 2). Some of these features will be automatically selected, according to their statistical properties, as being more important for the separation of spam from wanted messages. This selection of these features is performed with the same methods as the ones mentioned for the pornographic Web pages example, above. Then a machine learning algorithm combines these features in a probabilistic model, which represents the category “spam messages” for each language (drawing 1). In this example, the achievement of the most desired final result, is re-enforced by the fact that the training process uses examples of wanted messages from the users' personal mailbox and thus the filter arising there from is personalized.

Drawing 3 presents the second distinct stage of the invention, which concerns the process of filtering an electronic document. The evaluation of the examined electronic content is performed by the probabilistic fusion of many estimates.

First, as in the training stage and in particular the process of preparing the data presented in drawing 1, the document is separated into its constituent parts, which can be text, structural items (e.g. hyperlinks), digital images, digital sound/speech and digital video. In the case where some of the images contain text, this text is extracted by the images, using a common optical character recognition algorithm and it is added to the rest of the text, towards the extraction of textual features.

Then, as in the training stage of drawing 1, characteristic features are sought in each part of the content, using the appropriate algorithms for each part (drawing 2). The features that are sought now, during the filtering stage, are only those ones that have been selected during the training stage, as being important for the separation of the categories and which comprise the model. In this manner, a substantial speed-up of the feature localization is achieved, resulting to documents being filtered in a few milliseconds, if the method is implemented with the current computer systems.

Once identified, the features are combined in a vector of multimedia features, similar to the training stage of drawing 1, which is then passed to the trained probabilistic filtering models, in order to reach a decision about the category of the document, e.g. pornographic or non-pornographic Web page. For each language supported by the system, there exists a separate trained filtering model that produces a probabilistic estimate about the category the document belongs to.

In a non-limiting embodiment of the method described in drawing 3, where the goal of the system is the filtering of pornographic Web pages, characteristic features are sought, which have been selected during training as being important, in the text (e.g. phrases, frequency and distance between words, etc.), in digital images (e.g. number of images, average size, proportion of naked flesh in the images, appearance of human faces, existence of text in the images, etc.), as well as in the structural parts of the page (e.g. use of javascript, pop-ups, links to other Web pages known to be pornographic during training, etc.). These heterogeneous features are combined and are evaluated by each probabilistic model, in order to produce an estimate of the probability of a page being pornographic (drawing 3).

In another non-limiting embodiment of the method presented in drawing 3, the goal is to filter undesirable or/and undesired electronic mail messages (spam). In this case, the system searches for features that have been judged as important during training, in the text of the message (as explained in the example above for the Web pages), in potentially attached documents to the message (e.g. type, name and content of the attachment), as well as in the structural features of the body and the headers of the message (e.g. sender, originating site, difference between the sender's address and the originating site's address, etc.). These heterogeneous features are automatically combined by each probabilistic model, in order to produce a multimedia estimate per language, of the probability of a message to be spam.

In parallel to the generation of probabilistic estimates about the category of the document, the text of the document is used to estimate the language (or languages) in which it is written (language identification process in drawing 3). This can be achieved by one of the known language identification methods (e.g. the method presented in patent number U.S. Pat. No. 6,415,250), which generates probabilistic estimates of the language (or languages) in which the textual content is written.

Then, the probabilistic estimates about the language (or languages) of the text and the probabilistic estimates by the language-specific models, are combined through a probabilistic fusion function, in order to produce a unique and overall estimate about the category of the document. Due to the procedure that has been followed, this overall estimate is based on the multimedia features, as well as on the multilingual features of the document, which combines in a manner that constitutes an innovation of the present method.

In a non-limiting embodiment of the method described in drawing 3, where the goal of the system is to filter pornographic Web pages that may contain text in English and/or French and/or German, the system generates an estimate of the probability that each page contains text written in each of the three languages, as well as a different estimate that the page contains pornographic content according to the filtering models corresponding to each of the three different language. The six in total probability estimates that are generated, are combined by a fusion function, generating an overall estimate of whether the page is pornographic or not. Using this estimate and according to the final user's profile, i.e., if the user wants to block pornographic Web pages, the non-pornographic pages are forwarded to the user's browser, while for each pornographic page, identified as such, a special message appears that the Web page has been blocked by the filtering system.

In a non-limiting implementation of the fusion function, the final probability estimate P(C|x) that a document (x), e.g. a Web page, belongs in a category (C), e.g. pornography, is calculated as the sum of products of the probability P(yᵢ|x) that the document contains text in one of the languages (yᵢ) supported by the system, times the corresponding language-specific probabilities P(C|yᵢ, x) that the document belongs to the category, after appropriate normalization by ΣᵢP(yᵢ|x):

$$P ( C \vert x ) = \frac{{\sum }_{i} P ( C \vert {y}_{i} , x ) \cdot P ( {y}_{i} \vert x )}{{\sum }_{i} P ( {y}_{i} \vert x )}$$

To the same end, the above function can be replaced by various known fusion functions that appear in the literature. Furthermore, instead of using a pre-defined fusion function, it is possible to construct such a function using machine learning methods, in order to produce a function that is more suitable to the specific filtering task. For the construction of this function in such a manner, a separate set of training example documents is needed, belonging to the various categories of interest, e.g. pornographic and non-pornographic Web pages. Each one of those documents will be processed by the filtering method as described in drawing 3. The result of this process will be a set of probability estimates about the language (or languages) of the textual content of the page, the probability the document to belong to each of the categories of interest, according to the filtering models of the language-specific, together with the true category of the page, provided by the trainer/developer. Instead of combining these probabilities to produce an overall estimate for a document, as in drawing 3, they can be used for the generation of a training example. The set of training examples generated in this manner for all of the collected documents, will be analysed by a machine learning algorithm that will produce a probabilistic model for recognition of the categories of interest. This model can replace the fusion function in drawing 3.

The invention is widely applicable to all enterprises, industries, handicrafts, that use either Internet-based services or also an internal computer network, but applies also to the coverage of a wide range of personal needs of individual users, who make use of Internet-based services.

1) A method of filtering electronic content characterized by the fact that it filters multilingual and also semi-structured and also multimedia electronic content, using machine learning methods to train a separate model for each language for filtering a specific category of documents, where the model represents the documents by a unified representation (drawing 1), comprising characteristic features that are extracted automatically (drawing 2) from all the component parts of the document, and by the fact that it filters according to those models (drawing 3).

2) A method of filtering electronic content according to claim 1, characterized by the fact that the component parts of the document on which it is applied (drawing 2), can be components expressed in various modalities and/or components constituting structural items of the document.

3) A method of filtering electronic content according to claim 1, characterized by the fact that, among the characteristic features of the document it selects the most relevant ones, after having calculated their relatedness to the category to be filtered, by applying one of the known machine learning techniques.

4) A method of filtering electronic content according to claim 1, characterized by the fact that the languages in which the textual content might exist either in the training example documents (drawing 1) or in the document to be filtered (drawing 3) are identified automatically by probability estimates.

5) A method of filtering electronic content according to claim 1 and claim 4, characterized by the fact that the probability estimates about the languages of the textual content probably existing in the document to be filtered, are fused with the probability estimates about the category of the document, as they are produced by the language-specific filtering models (drawing 3), in order to estimate an overall probability for the document to belong in the filtered category.

6) A method of filtering electronic content according to claim 1, characterized by the fact that the final filtering decision for the content can be controlled by the user, through the selection of an adjustable probability/threshold (drawing 3), beyond which the document will be considered to belong in the filtered category.

7) A method of filtering electronic content according to claim 1 and claims 4 and 5, characterized by the fact that the fusion function that produces the overall decision is resulted by machine learning on probability estimates examples about the languages in which is written the existing textual content of the training examples documents and probability estimates of the language-specific models about the category it belongs.
